(19) United States
(12) Patent Application Publication
(10) Pub. No.: US 2011/0146615 A1
(43) Pub. Date: Jun. 23, 2011

(54) Non-Crankshaft Engine

(76) Inventor: Huarong Xia, Tianjin City (CN)

(21) Appl. No.: 12/227,390

(22) PCT Filed: Sep. 21, 2006
(86) PCT No.: PCT/CN2006/002469

§ 371 Date: Nov. 13, 2008

(30) Foreign Application Priority Data
Sep. 22, 2005 (CN) 200510015166.1

(51) Int. Cl. F02B 75/32

(52) U.S. Cl. 123/197.1

(57) ABSTRACT

This invention discloses a non-crankshaft engine which includes the body, the cylinder head on top of the body, and the cylinder inside it. A piston intersecting with one end of a connecting rod is set in the cylinder. In the middle of the chassis where the engine body is set on, there is the basic shaft which intersects with one or more crossbars perpendicularly in way of either fixed joint or swing joint. On the crossbar is installed symmetrically on either side of the axis of the basic shaft a fixing set. It connects with the other end of the connecting rod through a swing joint. Every fixing set is joined by one or two connecting rods linked with the piston. The above structure of basic shaft, crossbar and connecting rod will result in strong explosion pressure that can produce great moment of force, and thus give the utmost work. Therefore, this invention has the advantages of high working efficiency, low energy-consumption, and is expected to produce minimum environmental pollution.

### BACKGROUND OF THE INVENTION

(a) Technical Field of the Invention

This invention involves an internal combustion engine system, especially a non-crankshaft engine, which has the advantages of high working efficiency, low energy consumption, and is expected to produce minimum environmental pollution.

(b) Description of the Prior Art

The traditional motion components of the engine (internal combustion engine: diesel engine, petrol engine and other gas engine fueled by natural gas, including two-stroke and four-stroke engines, etc.) are fundamentally made up of the crankshaft (10) (including the shaft journal (11) and the crank (12)), connecting rod (2), and the piston (1), as is described in FIGS. 14 and 15. In the operation, the explosion stroke starts with piston (1) being at or close to the upper stop point. The huge swelling pressure from the burning of the fuel has little or no effect on the rotation of crankshaft. Due to minimum or virtually no distance between the centre line of crankshaft (10) and the application point of the force transmitting through the piston (1), connecting rod (2) and crank (12) to the crankshaft (10), minimum or virtually no moment is produced. As a result, crankshaft (10) does not run properly, which leads to minimum or virtually no power from its running. Therefore, the most serious defects of traditional internal combustion engine are low efficiency, high energy-consumption and serious environmental pollution.

### SUMMARY OF THE INVENTION

The primary purpose of the present invention is to provide a non-crankshaft engine with high working efficiency, low energy-consumption, and environmental-friendliness.

The technical scheme adopted in the invention is: a non-crankshaft engine which includes the body, the cylinder head on top of the body, and the cylinder inside it. A piston intersecting with one end of a connecting rod is set in the cylinder. In the middle of the chassis where the engine body is set on, there is the basic shaft which intersects with crossbar perpendicularly in way of either fixed joint or swing joint. On the crossbar is installed symmetrically on either side of the axis of the basic shaft a fixing set. It connects with the other end of the connecting rod through a swing joint.

The above said basic shaft connects with one or more crossbars. Every fixing set on the crossbar has one or two connecting rods which connect with the piston.

When the piston is at one of the stop point of cylinder head, the center line of cylinder head will intersect with the perpendicular of crossbar's center line at an angle of φ, where φ is equal to or greater than 0° but smaller than 30° (0°≦φ<30°); Meanwhile, the center line of connecting rod intersects with that of cylinder at an angle of β₀, where β₀ is equal to or greater than 0° but smaller than 15° (0°≦β₀<15°).

Another technical scheme adopted in the invention is a non-crankshaft engine including the body, the cylinder head on top of the body, and the cylinder inside it. Piston in cylinder is connected with one end of the connecting rod. In the middle of the chassis where the engine body is set on, there is the basic shaft which intersects with two or more crossbar perpendicularly in way of either fixed or swing joints. On one side of the basic shaft is a crossbar installed either with a fixing set or with the power output unit, and on the other side is a crossbar with the same installments (but in reverse order). The fixing set connects with the other end of the connecting rod through a swing joint.

When the piston is at one of the stop point of cylinder head, the center line of cylinder head will intersect with the perpendicular of crossbar's center line at an angle of φ, where φ is equal to or greater than 0° but smaller than 30° (0°≦φ<30°); Meanwhile, the center line of connecting rod intersects with that of cylinder at an angle of β₀, where β₀ is equal to or greater than 0° but smaller than 15° (0°≦β₀<15°).

As the non-crankshaft engine whose basic shaft, crossbar and the connecting rod have adopted the above structure, it is possible to choose the suitable distance between the application point of the swelling pressure generated at the beginning of the explosion stroke and the center line of the basic shaft. The choice is made according to the needs of power of engine, the dimension of the cylinder bore and the stroke. In this way, the arm of force between the application point of the explosion pressure and the basic shalt are extended dramatically so that a large moment is exerted which produces maximum work. Therefore, the engine has the advantages of high working efficiency, low energy consumption, and minimum environmental pollution.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1-1 is the schematic representation of the fixed joint between crossbar and the basic shaft;

FIG. 1-2 is the plan view of FIG. 1-1;

FIG. 1-3 is the sectional view of the A-A in FIG. 1-2;

FIG. 1-4 is the sectional view of the B-B in FIG. 1-2;

FIG. 2-1 is the schematic representation of the non-crankshaft engine when crossbar and the basic shaft connect with each other through a fixed joint;

FIG. 2-2 is the plan view of FIG. 2-1;

FIG. 3-1 is the schematic representation of the non-crankshaft engine when all the bodies are joined together;

FIG. 3-2 is the plan view of FIG. 3-1;

FIG. 4-1 is another schematic representation of the non-crankshaft engine in actualized structure when all the bodies are joined together;

FIG. 4-2 is the plan view of FIG. 4-1;

FIG. 5 is the schematic representation of the non-crankshaft engine when piston, connecting rod, crossbar and the basic shaft are under stress at the beginning of the explosion stroke;

FIG. 6 is the schematic representation of the non-crankshaft engine in operation when the piston, the connecting rod and the basic shaft are under pressure and the basic shaft rotates at an angle of α;

FIG. 7 and FIG. 9 are the schematic representation of the non-crankshaft engine installed with some auxiliary unit;

FIG. 8 is the plan view of FIG. 7;

FIG. 10 is the plan view of FIG. 9;

FIG. 11 is the schematic representation of the non-crankshaft engine installed with some power output unit;

FIG. 12 is the plan view of FIG. 11;

FIG. 13 demonstrates the forces on the connecting rod, crossbar and the basic shaft in the non-crankshaft engine;

FIG. 14 is the representation of the diesel engine 6130 in prior art when piston, connecting rod, crank, and the shaft journal are under stress at the beginning of explosion stroke;

FIG. 15 is the structure sketch of the piston, the connecting rod, crank and shaft journal of the diesel engine 6130 in prior art when the piston travels across the upper dead point and the crankshaft rotate at an angle of α;

FIG. 16 demonstrates the forces on the piston, the connecting rod, crank and shaft journal of the diesel engine 6130 in prior art when the piston travels across the upper dead point and the crankshaft rotate at an angle of α;

In the figure:
1: piston 2 connecting rod 3: crossbar 4: basic shaft 5: cylinder head 6: the body 7: air cylinder 8: fixing set 9: chassis 10: crankshaft 11: shaft journal 12: crank 13: auxiliary unit 14: hydrocylinder 15: spring 16: pull rod 17: support 18: power output unit

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention.

Various changes to the described embodiments may be made in the function and arrangement of the elements described without departing from the scope of the invention as set forth in the appended claims.

The operation of the non-crankshaft engine is illustrated in detail with the help of actualized structure and figures.

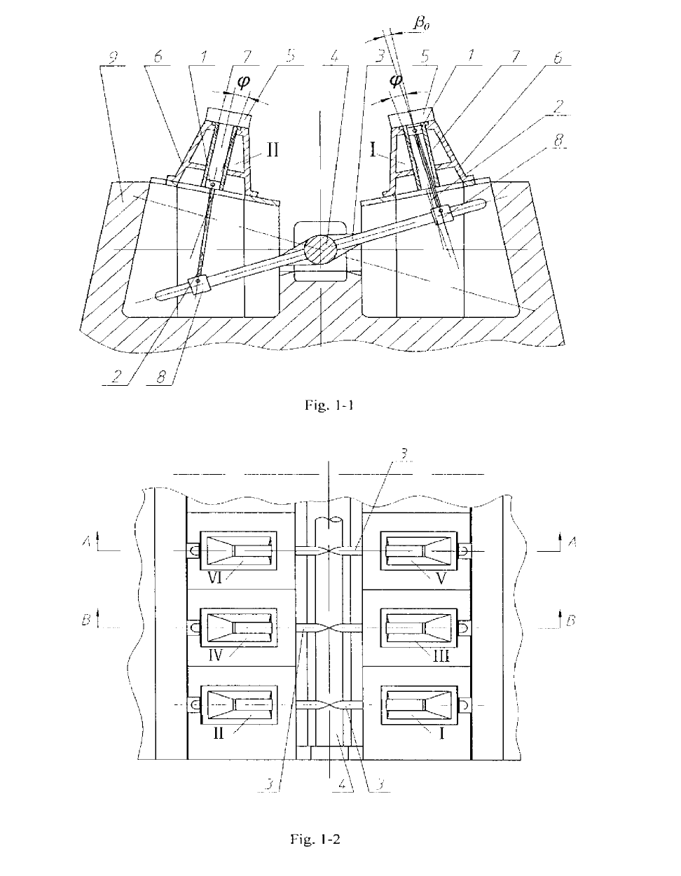

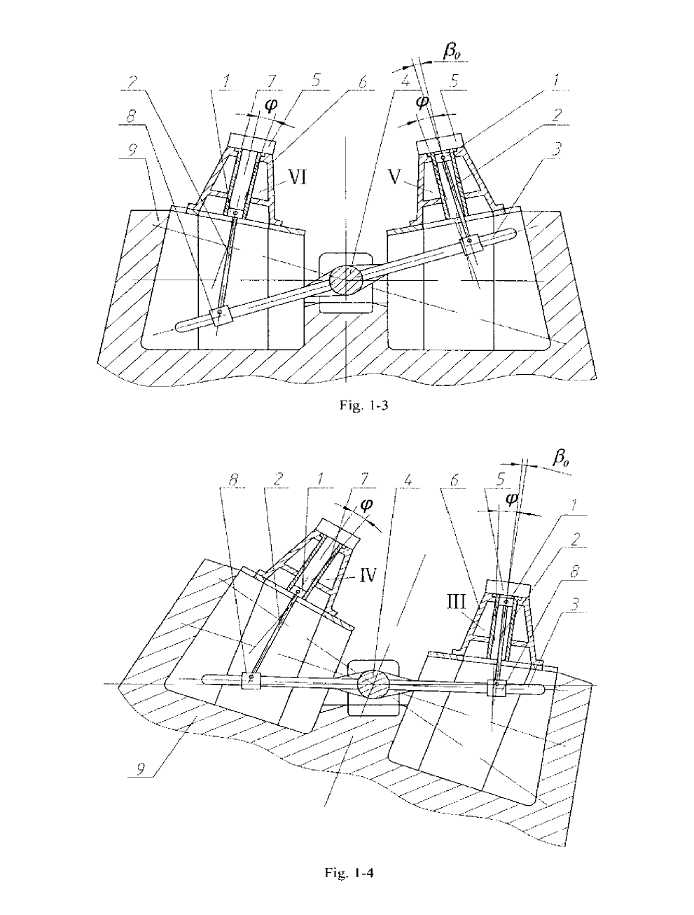

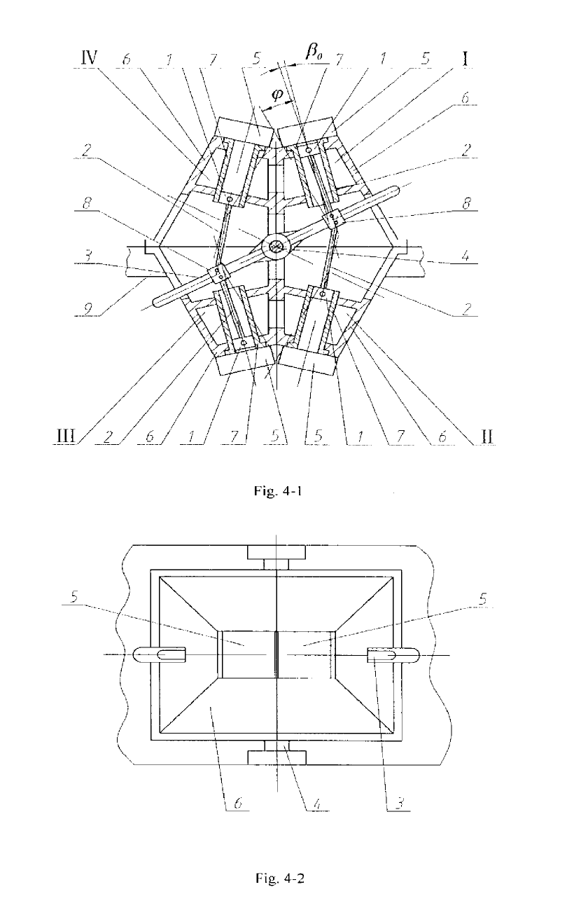

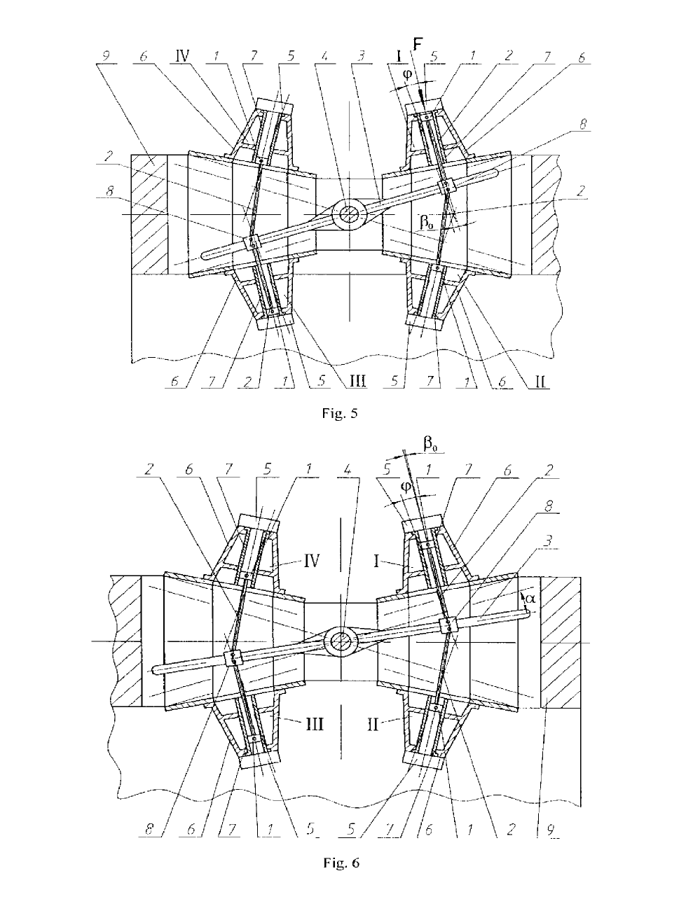

As is described in the FIG. 1-1, 1-2, 1-3, and FIG. 1-4, the non-crankshaft engine includes the body (6), the cylinder head (5) on top of the body (6), and the cylinder (7) inside it. Piston (1) in cylinder (7) is connected with one end of the connecting rod (2). In the middle of the chassis (9) where the engine body (6) is set on, there is the basic shaft (4) which intersects with one or more crossbar (3) perpendicularly in way of either fixed joint or swing joint. The structures of swing joint can be rolling bearing, the shaft sleeve and shaft bushing, ratchet and pawl, etc.; fixed joint in structures of the welding, thread fastening and thread connecting, etc.

The basic shaft (4) and crossbar (3) are connected in the way of fixed joint as is described in the above figure. On the crossbar (3) is installed symmetrically on either side of the axis of the basic shaft (4) a fixing set (8). The fixing set (8) connects with the other end of the connecting rod (2) through a swing joint, such as the joint with hinge, bearing, and bearing block, etc.

As is described in the FIG. 1-1, 1-2, 1-3, 1-4, 2-1, 3-1, 4-1, 5 and FIG. 6, every fixing set (8) on the crossbar (3) holds one or two connecting rods (2) which connect with piston (1). If there is just one connecting rod (2) on each fixing set (8), they are on the same side of the crossbar (3), while if there are two, the two connecting rods (2) are symmetrically installed on the either side of the crossbar (3).

The above FIG. 1-4 shows that crossbar (3)'s center line on the basic shaft and the center line of some other crossbar (3) on the same basic shaft may be on the same plane on the condition that they rotate synchronously at the same angle.

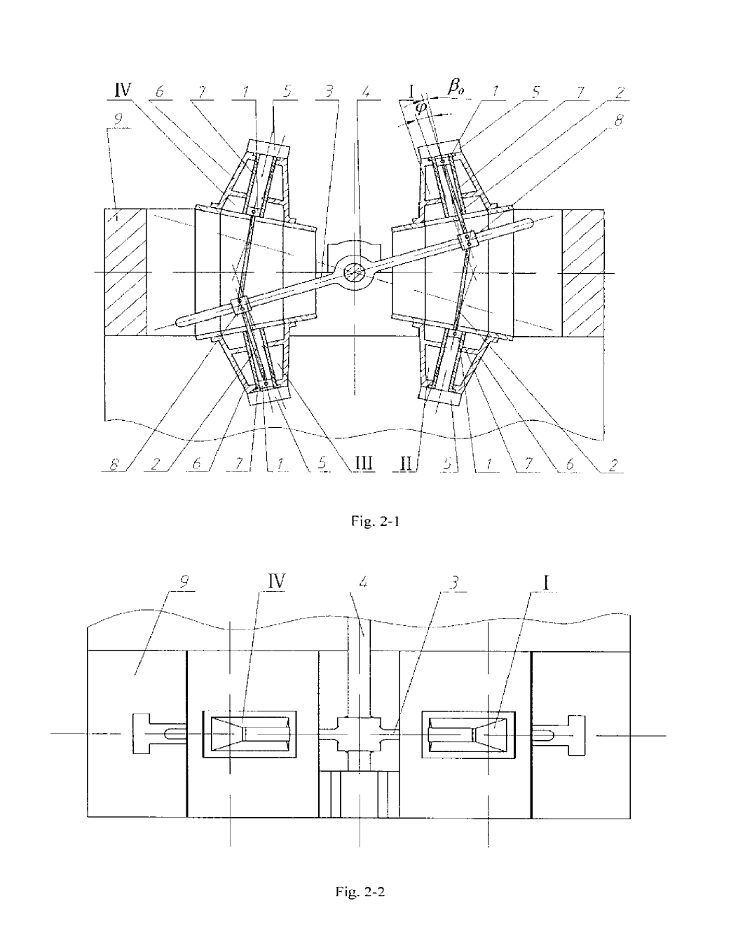

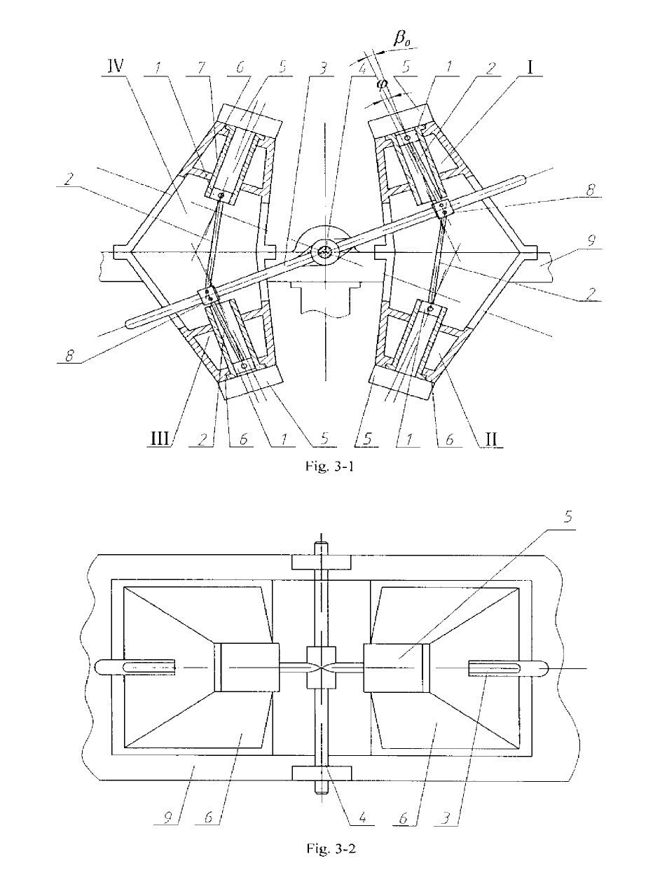

In FIG. 2-1, it is fixed joint between the basic shaft (4) and crossbar (3); while in FIG. 3-1, 4-1, 5 and FIG. 6, it is swing joint.

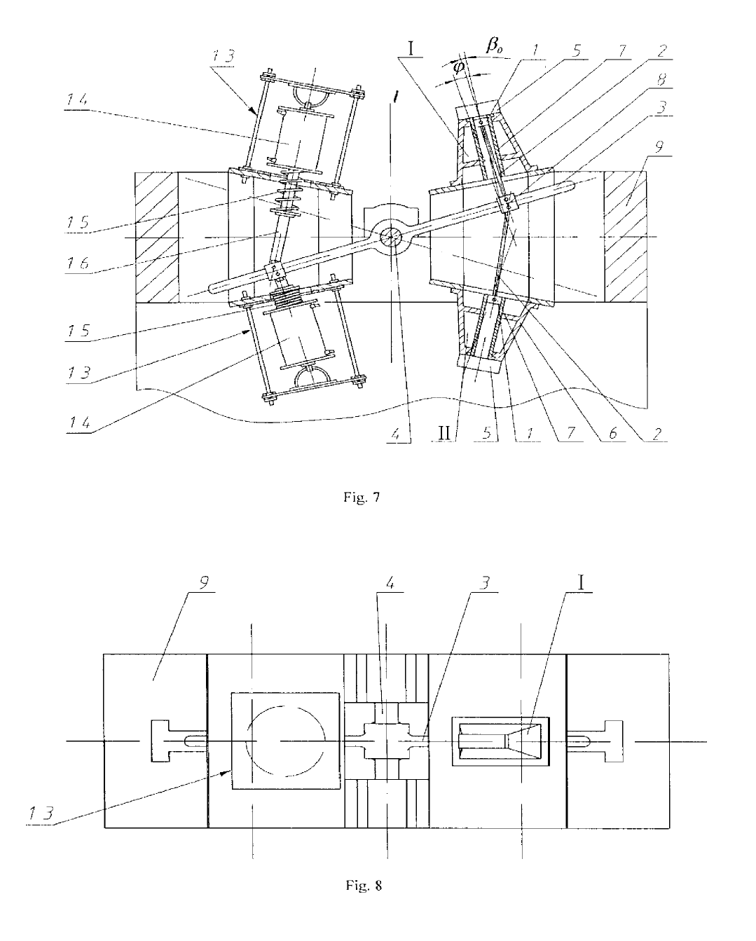

As is described in the FIGS. 7, 8, 9 and 10, the non-crankshaft engine may also include the body (6), the cylinder head (5) on top of the body (6), and the cylinder (7) inside it. Piston (1) in cylinder (7) is connected with one end of the connecting rod (2). In the middle of the chassis (9) where the engine body (6) is set on, there is the basic shaft (4) which intersects with one or more crossbars (3) perpendicularly in way of either fixed joint or swing joint. Swing joint can be in the structures of the rolling bearing, shaft sleeve and shaft bushing, ratchet and pawl, etc.; fixed joint in structures of welding, thread fastening and thread connecting, etc. On one side of the basic shaft is crossbar (3) installed either with a fixing set (8) or with some auxiliary unit (13) that enables the connecting rod of the piston to run continuously and normally, and on the other side is a crossbar (3) with the same installments (but in reverse order). The fixing set (8) connects with the other end of the connecting rod (2) through a swing joint.

There is one or more crossbars (3) connected with the basic shaft (4). Moreover, every fixing set (8) on the crossbar (3) holds one or two connecting rods (2) which connect with piston (1). If there is just one connecting rod (2) on each fixing set (8), they are on the same side of the crossbar (3), while if there are two, the two connecting rods (2) are symmetrically installed on either side of the crossbar(3).

FIG. 7 shows that when there are two connecting rods(2) on the fixing set (8) installed on crossbar(3) on one side of the basic shaft (4) to accomplish only two strokes, two sets of auxiliary units (13) are installed symmetrically on the crossbar (3) on the other side of the basic shaft (4) to help accomplish another two strokes. Therefore, four strokes are completed.

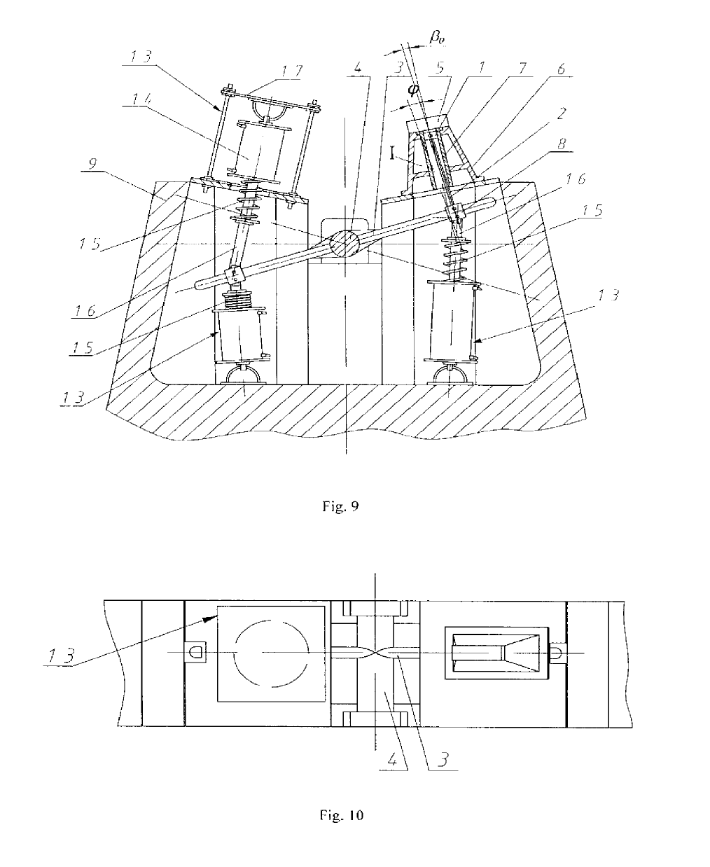

As is showed in FIG. 9, the fixing set(8) on the crossbar(3) which is on one side of the basic shaft(4) is equipped with a connecting rod(2). When only one stroke is completed, an auxiliary unit (13) provided between the cylinder (7) and the crossbar (3) which is equipped with a fixing set (8), completes other three strokes together with the two auxiliary units (13) on the crossbar (3) on the other side of the basic shaft (4). Thus four strokes are completed.

As in FIG. 9, the auxiliary unit (13) can choose the way how the hydrocylinder (14) should be connected with the spring (15) and the pull rod (16). One side of the crossbar (3) is flexibly connected with one end of a pull rod (16), the other end of which is connected to the hydrocylinder (14) inside the chassis (9) through a spring (15). In the same way, the other side of the crossbar(3) is flexibly connected with one end of a pull rod(16), the other end of which is connected through a spring(15) to the hydrocylinder (14) which is connected with a support(17) fixed on the chassis(9).

The auxiliary unit (13) can also choose the structures of hydrocylinder, hydrocylinder with lever, cylinder, and cylinder with spring or cylinder with lever.

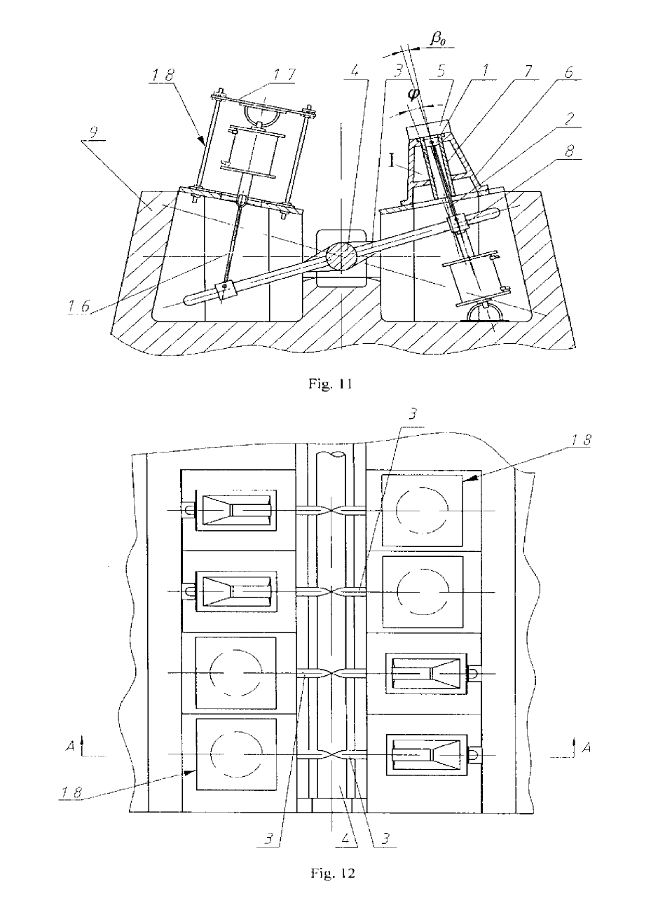

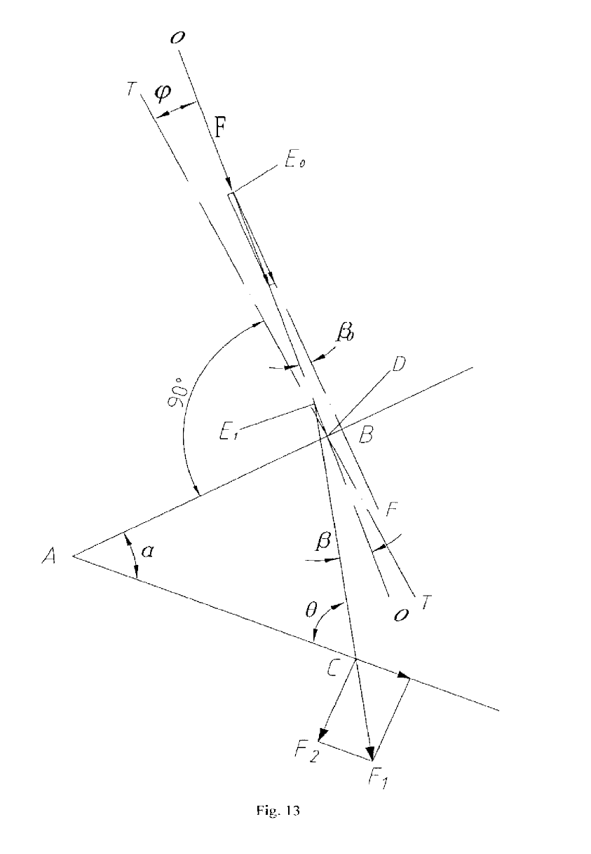

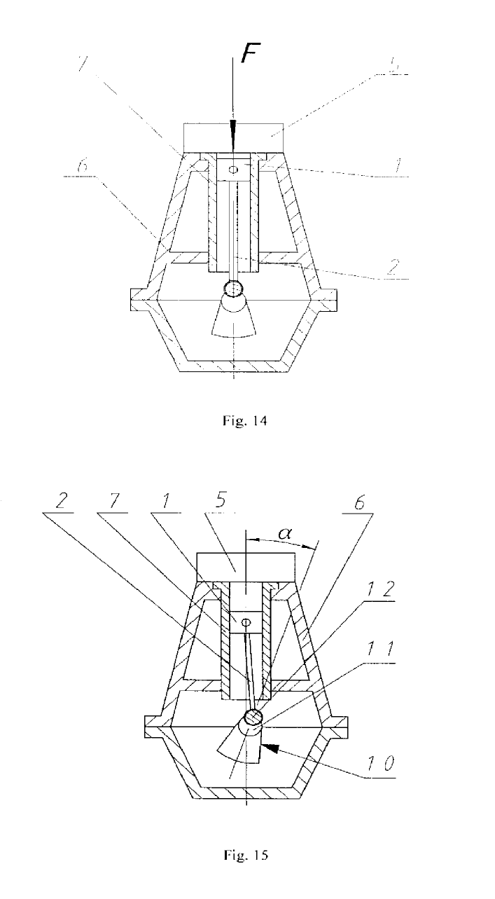

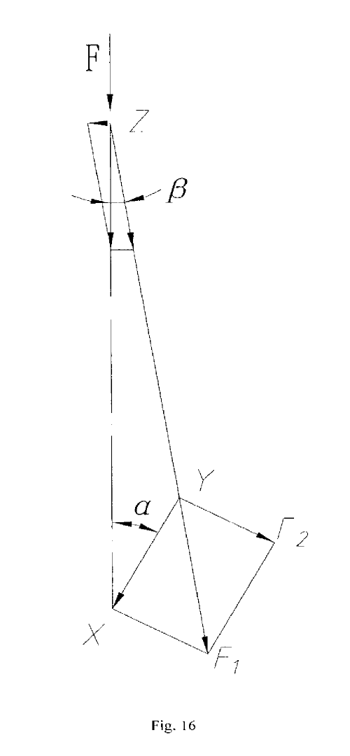

As in FIGS. 11 and 12, the invented non-crankshaft engine comprises a body (6), a cylinder head (5) on top of the body, and a cylinder (7) inside it. Piston (1) in the cylinder (7) is connected with one end of a connecting rod (2); the body (6) is fixed on a chassis(9), in the center of which is a basic shaft (4), perpendicularly connected with a crossbar(3), the number of which can be 2 or n×2. The crossbar (3) on one side of the basic shaft(4) is provided either with a fixing set (8) or with a power output unit (18), while the crossbar (3) on the other side is provided with the same installments but in reverse order. The fixing set (8) is flexibly connected with the other end of the connecting rod (2). Each fixing set (8) on the crossbar(3) is connected with one or two connecting rods (2) which are also connected to piston(1). The connecting rods (2) are on the same side of the crossbar (3) when each fixing set (8) is connected with one connecting rod (2), and they are symmetrically distributed on different sides when there are two.

The power output unit (18) of the invention can comprise hydrocylinders or hydrocylinders with spring. The power output unit (18) is connected to the crossbar (3) through a pull rod (16), where the latter two are in swing joint.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A non-crankshaft engine is composed of the body (6), the cylinder head (5) on top of the body, and the cylinder (7) inside it. Piston (1) in the cylinder (7) is connected with one end of the connecting rod (2). The features are as follows. In the middle of the chassis (9) where the engine body is set on, there is the basic shaft (4) which intersects with crossbar (3) perpendicularly in way of either fixed joint or swing joint. On the crossbar (3) is installed symmetrically on either side of the axis of the basic shaft (4) a fixing set(8). It connects with the other end of the connecting rod (2) through a swing joint.

2. The non-crankshaft engine described in Requirement 1 has the following features. The basic shaft (4) connects with one or more crossbars (3).

3. The non-crankshaft engine described in Requirement 1 has the following features. Every fixing set(8) on the crossbar (3) holds one or two connecting rods (2) which connect with the piston (1).

4. The non-crankshaft engine described in Requirement 1 has the following features. When piston (1) is at one of the stop point of the cylinder head (5), the center line of cylinder head (7) will intersect with the perpendicular of crossbar (3)'s center line at an angle of φ, where φ is equal to or greater than 0° but smaller than 30° (0°≦φ<30°); Meanwhile, the center line of connecting rod (2) intersects with that of cylinder (7) at an angle of β₀, where β₀ is equal to or greater than 0° but smaller than 15° (0°≦β₀<15°).

5. A non-crankshaft engine includes the body (6), the cylinder head (5) on top of the body, and the cylinder (7) inside it. Piston (1) in cylinder (7) is connected with one end of the connecting rod (2). The features are as follows. In the middle of the chassis (9) where the engine body is set on, there is the basic shaft (4) which intersects with crossbar (3) perpendicularly in way of either fixed joint or swing joint. On one side of the basic shaft is crossbar (3) installed either with a fixing set (8) or with some auxiliary unit (13) that enables the connecting rod of the piston to run continuously and normally, and on the other side is a crossbar (3) with the same installments (but in reverse order). The fixing set (8) connects with the other end of the connecting rod (2) through a swing joint.

6. The non-crankshaft engine described in Requirement 5 has the following features. The basic shaft (4) connects with one or more crossbars (3).

7. The non-crankshaft engine described in Requirement 5 has the following features. Every fixing set(8) on the crossbar (3) has one or two connecting rods (2) which connect with the piston (1).

8. The non-crankshaft engine described in Requirement 5 has the following features. When piston (1) is at one of the stop point of cylinder head (5), the center line of cylinder head (7) will intersect with the perpendicular of crossbar (3)'s center line at an angle of φ, where φ is equal to or greater than 0° but smaller than 30° (0°≦φ<30°); Meanwhile, the center line of connecting rod (2) intersects with that of cylinder (7) at an angle of β₀, where β₀ is equal to or greater than 0° but smaller than 15° (0°≦β₀<15°).

9. A non-crankshaft engine includes the body (6), the cylinder head (5) on top of the body, and the cylinder (7) inside it. Piston (1) in cylinder (7) is connected with one end of the connecting rod (2). The features are as follows. In the middle of the chassis (9) where the engine body is set on, there is the basic shaft (4) which intersects with two or more crossbars (3) perpendicularly in way of either fixed joint or swing joint. On one side of the basic shaft (4) is crossbar (3) installed either with a fixing set (8) or with the power output unit(18), and on the other side is a crossbar(3) with the same installments (but in reverse order). The fixing set (8) connects with the other end of the connecting rod (2) through a swing joint.

10. The non-crankshaft engine described in Requirement 9 has the following features. When piston (1) is at one of the stop point of cylinder head (5), the center line of cylinder head (7) will intersect with the perpendicular of crossbar (3)'s center line at an angle of φ, where φ is equal to or greater than 0° but smaller than 30° (0°≦φ<30°); Meanwhile, the center line of connecting rod (2) intersects with that of cylinder (7) at an angle of β₀, where β₀ is equal to or greater than 0° but smaller than 15° (0°≦β₀<15°).
